(19) United States
(12) Patent Application Publication
(10) Pub. No.: US 2025/0389030 A1
(43) Pub. Date: Dec. 25, 2025

(54) INTELLIGENT CORROSION PROTECTION AND MONITORING SENSOR SYSTEM AND METHOD THEREOF

(71) Applicant: Nano and Advanced Materials Institute Limited, Hong Kong (CN)

(72) Inventors: Kuijiao LI, Hong Kong (CN); Youyi WEI, Hong Kong (CN); Yanmin WU, Hong Kong (CN)

(21) Appl. No.: 18/752,811

(22) Filed: Jun. 25, 2024

(51) Int. Cl. C23F 13/22; G01N 17/02

(52) U.S. Cl. CPC C23F 13/22; G01N 17/02

(57) ABSTRACT

Provided are an intelligent corrosion protection and monitoring sensor system, and a method thereof. The intelligent corrosion protection and monitoring sensor system includes an anode plate, and a thickness of a middle portion of the anode plate is smaller than that of two side portions of the anode plate to form a bridge-shaped structure. The anode plate is mounted on a steel structure, there is a gap between the middle portion of the anode plate and the steel structure, and the two side portions of the anode plate are in contact with the steel structure. A piezoelectric sheet is provided on a side surface, away from the steel structure, of the middle portion of the anode plate, and the piezoelectric sheet is electrically connected to a monitoring control system.

### TECHNICAL FIELD

The present disclosure relates to the technical field of steel structure corrosion protection, and in particular to an intelligent corrosion protection and monitoring sensor system and a method thereof.

### BACKGROUND

Steel modular integrated building is also called steel structure modular integrated building (MiC). The corrosion of steel connectors between building modules will lead to structural safety problems in MiC buildings, which is a common concern of the industry and government agencies, and a puzzle for building users. Therefore, regular inspection is required, but the inspection is time-consuming and labor-intensive, leading to interference to residents. In the related prior art, for example, in the Chinese invention patent with publication number of CN112761247A, a prefabricated box-plate steel structure anti-corrosion building system and a construction method thereof are provided. A sacrificial anode-cathode protection system is mounted at the bottom of the box-plate steel structure building, which can slow down corrosion and improve durability, but cannot monitor the corrosion condition and does not solve the problem of potential safety hazards investigation.

### SUMMARY

A technical problem to be solved by the present disclosure is that an intelligent corrosion protection and monitoring sensor system and a method thereof are provided, the problem that it is inconvenient to inspect the corrosion condition of the steel structure regularly in the existing technical solution is solved. The system provided by the present disclosure is particularly suitable for a steel modular integrated building, can provide real-time, remote and autonomous monitoring for the structural corrosion situation conditions in the large-scale application of steel modular integrated buildings, and provide active protective measures, thus improving the reliability and safety of the structure, finding and removing potential safety hazards in time, and reducing the maintenance cost.

According to the technical solution provided by the present disclosure, an intelligent corrosion protection and monitoring sensor system is provided, including an anode plate. A thickness of a middle portion of the anode plate is smaller than that of two side portions of the anode plate to form a bridge-shaped structure. The anode plate is mounted on a steel structure, a gap is formed between the middle portion of the anode plate and the steel structure, and the two side portions of the anode plate are in contact with the steel structure. A piezoelectric sheet is provided on a side surface, away from the steel structure, of the middle portion of the anode plate, and the piezoelectric sheet is electrically connected to a monitoring control system. The monitoring control system is capable of controlling application of a voltage to the piezoelectric sheet to make the piezoelectric sheet generate mechanical vibration and transmit the mechanical vibration to the anode plate and the steel structure. The monitoring control system is also capable of measuring and analyzing a voltage change of the piezoelectric sheet caused by the mechanical vibration so as to monitor a corrosion condition.

Preferably, an encapsulation layer is covered on the piezoelectric sheet and the anode plate around the piezoelectric sheet. It is further preferred to employ epoxy resin protective encapsulation in this technical solution, which not only can protect the piezoelectric sheet from environmental factors, but also can enhance the integrity of an overall structure of the sensor system, thus providing better mechanical impact resistance and chemical corrosion protection.

Preferably, the anode plate and the steel structure are mounted and connected by a bolt connector. In this technical solution, the anode plate and the steel structure are fixedly connected by a bolt, such that the anode plate serving as a sacrificial anode is easy to replace.

Preferably, the two side portions of the anode plate and the steel structure are provided with bolt holes. The bolt connector includes a ceramic bolt and a ceramic nut which are matched with each other, and the ceramic bolt passes through the bolt hole. A ceramic material has better chemical corrosion resistance than metals, and thus the introduction of an additional corrosion source into a metal corrosion monitoring system can be avoided.

Preferably, the anode plate is a zinc plate, and/or, the piezoelectric sheet is a lead zirconate titanate piezoelectric sheet. The zinc plate which is used as the anode plate has relatively suitable chemical activity, machinability and cost, and the lead zirconate titanate piezoelectric sheet has better positive piezoelectric effect and inverse piezoelectric effect, and is small, and low in cost. Therefore, this technical solution is easier for practical application.

Preferably, the monitoring control system includes an electrochemical impedance spectrometer. The electrochemical impedance spectrometer can provide required AC (alternating current) voltages with different frequencies for the piezoelectric sheet, and can be used to measure impedance, thus reflecting a voltage generated by the piezoelectric effect in the data of impedance or admittance to achieve the control of the piezoelectric sheet and the monitoring of corrosion conditions.

Preferably, a thickness of the middle portion of the anode plate is 5 mm, and the two side portions have a thickness of 10 mm. In this technical solution, the anode plate with such a specific rectangular bridge-shaped structure can better enhance signal detection of the piezoelectric sheet, and improve the sensitivity of corrosion signal transmission, i.e., improving the monitoring sensitivity, and optimizing the corrosion detection efficiency.

According to the technical solution of the present disclosure, a method for manufacturing an intelligent corrosion protection and monitoring sensor system is further provided. The method is used for manufacturing the intelligent corrosion protection and monitoring sensor system, and includes the following steps:
Step S11, welding a wire to a piezoelectric sheet;
Step S12, heating an anode plate on a heating stage, and fixing the piezoelectric sheet to a middle portion of the anode plate using a lead-free solder and solder paste, pressing against the piezoelectric sheet using an iron nugget to ensure that the lead-free solder melts completely and is attached firmly between the anode plate and the piezoelectric sheet; and completing the fixation of the piezoelectric sheet and the anode after cooling;
Step S13, encapsulating the piezoelectric sheet and the anode plate using epoxy resin, cooling, and then hardening the epoxy resin to form an encapsulation layer; and
Step S14, mounting and fixing the anode plate to the steel structure by bolted connection.

According to the technical solution of the present disclosure, an application method of an intelligent corrosion protection and monitoring sensor system is further provided. The intelligent corrosion protection and monitoring sensor system is adopted, and the method includes the following steps:
Step S2, soaking a steel structure and an anode plate in a solution to simulate a corrosive environment, and performing electrochemical impedance test and data acquisition and analysis through a monitoring control system;
performing the electrochemical impedance test and data acquisition and analysis further includes the following steps:
Step S21, respectively recording an initial weight of the anode plate and a current weight of the anode plate after corrosion at different corrosion time; applying an AC (alternating current) voltage with a frequency of 10 kHz-30 kHz to the piezoelectric sheet through the monitoring control system at different corrosion time, making the piezoelectric sheet vibrate, then monitoring and recording frequency resonance of the piezoelectric sheet caused by the corrosion of the anode plate, and collecting admittance to form a data record form and/or a data relationship graph; and obtaining resonance frequencies of the anode plate in a plurality of different corrosion states according to a relationship between the admittance and the frequency in the data record form and/or the data relationship graph;
Step 22, calculating a frequency offset rate and a corrosion rate of the anode plate according to the data obtained in Step S21,

$$where frequency offset rate = ( current resonance frequency - initial resonance frequency ) / initial frequency ; and$$

$$corrosion rate = ( initial weight - current weight ) / initial weight / corrosion time ;$$

Step 23, according to the data obtained in Step S22, obtaining a linear function relationship between the frequency offset rate and the corrosion rate by linear regression analysis; and
Step 24, for the intelligent corrosion protection and monitoring sensor system applied to the steel structure mounted in practical engineering, performing electrochemical impedance test and data acquisition and analysis through a monitoring control system, and predicting a frequency offset rate and/or a corrosion rate based on the linear functional relationship between the frequency offset rate and the corrosion rate obtained in step S23, thus monitoring a corrosion condition.

Further, the intelligent corrosion protection and monitoring sensor systems are distributed at different node positions of a steel modular integrated building. The method further includes Step S3, continuously monitoring by the monitoring control system at set time intervals, and generating a visualization chart to reflect a corrosion condition at each position of the steel modular integrated building, and/or giving an alarm to remind staff to check and intervene in time.

Compared with the prior art, the present disclosure has the main beneficial effects as follows:

1. An anode plate is mounted on a steel structure, and a sensor system can actively slow down the corrosion speed of a steel plate and improve the durability of a steel structure using sacrificial anode protection principle. A bridge-shaped structure of the anode plate not only improves the sensitivity of a monitoring system on early corrosion signs, but also improves the detection accuracy by improving the quality of mechanical-to-electrical signal conversion and concentrating the detection ability in the most critical area of the anode plate. Therefore, according to such a preferred design, the system can provide timely and accurate structure health evaluation more effectively, especially in an environment with large corrosion risks. Meanwhile, it is a deliberate design choice to improve the performance and reliability of a corrosion monitoring system by preventing a middle portion of the anode plate from making direct contact with the steel structure, which is conducive to maintaining the accuracy of detecting a corrosion signal by the sensor system and ensuring the service life and effectiveness. Moreover, the present disclosure is more conducive to achieving tailor-made frequency response: bridge-shaped designs with different thicknesses can be tuned to a specific resonance frequency that is most affected by the corrosion process. Due to such an adjustment, the system can be highly responsive to specific types of corrosion expected in a sensor deployment environment.

2. According to the technical solution, the positive and inverse piezoelectric effects of the piezoelectric sheet are comprehensively applied. The positive piezoelectric effect is used to detect an electrical signal generated by structural change, and the inverse piezoelectric effect is used to generate structural vibration. Such a comprehensive application can accurately control and measure the response of the structure. The effectiveness of structural health monitoring is enhanced by the dual functions of the piezoelectric sheet in actuation and sensing. This integration not only simplifies the design and operation of the system, but also improves the accuracy, efficiency, and responsiveness of monitoring, and greatly enhances its application efficiency and flexibility in structural health monitoring, which is crucial for maintaining the safety and integrity of a building structure.

3. According to the present disclosure, the nondestructive inspection of the structure integrity is achieved, and there is no need to perform physical cutting or sampling analysis on the structure itself.

4. The piezoelectric sheet can be easily integrated into various structures due to its small size and light weight, and in cooperation with an automatic data collection and analysis system, the manual monitoring demand is reduced.

5. The accuracy of data analysis is higher, the finer quality data and change and frequency data mean that the change of physical and chemical properties of the anode plate caused by corrosion can be drawn more accurately. Such an accuracy is crucial for developing a reliable corrosion process prediction model.

6. A potential problem can be predicted by continuously monitoring a health status of the structure, the replacement is convenient after the zinc plate is corroded. This technical solution is conducive to improving preventive maintenance efficiency of the steel structure, thus avoiding unexpected failures, and reducing the risk of emergencies.

7. This technical solution has a wide application potential, which is not only suitable for the steel structure building, but also can be extended to other systems made of steel structures. The corrosion status of the structure can be remotely monitored in real time, maintenance teams can know and make response to corrosion problems in time without going to the site for inspection. The technical solution provided by the present disclosure may also be applied to remote health monitoring of other complicated engineering structures, such as bridges and ships.

### BRIEF DESCRIPTION OF THE DRAWINGS

FIG. 1 is a structural diagram of an intelligent corrosion protection and monitoring sensor system according to an embodiment of the present disclosure;

FIG. 2 is a structural schematic diagram of a steel modular integrated building according to an embodiment of the present disclosure;

FIG. 3 is a schematic diagram of a three-dimensional structure of an anode plate according to an embodiment of the present disclosure;

FIG. 4a is a graph of a frequency-admittance relationship measured by adopting the technical solution of an ordinary plate-like anode plate;

FIG. 4b is a graph of a frequency-admittance relationship measured by adopting the technical solution of a bridge-shaped plate-like anode plate according to the present disclosure;

FIG. 5 is a schematic diagram of dimensioning of an anode plate according to an embodiment of the present disclosure;

FIG. 6 is a comparison diagram of corrosion experimental results of the technical solution that the thicknesses of a middle portion of the anode plate are 3 mm, 4 mm, and 5 mm;

FIG. 7 is a graph of a frequency-admittance relationship under different degrees of corrosion of experimental data according to an embodiment of the present disclosure;

FIG. 8 is a diagram of a linear function relationship between a frequency offset rate and a corrosion rate obtained by linear regression analysis of experimental data according to an embodiment of the present disclosure;

FIG. 9 is an overall schematic diagram of an intelligent corrosion protection and monitoring sensor system according to an embodiment of the present disclosure and an application mode thereof.

Numeral references in the drawings are as follows:
1—steel structure; 2—anode plate; 21—middle portion; 22—two side portions; 23—bolt collector; 24—bolt hole; 3—piezoelectric sheet; 31—wire; 4—encapsulation layer; 5—monitoring control system.

### DETAILED DESCRIPTION OF THE EMBODIMENTS

An intelligent corrosion protection and monitoring sensor system and a method thereof are provided. the problem that it is inconvenient to inspect the corrosion condition of the steel structure regularly in the existing technical solution is solved. The system provided by the present disclosure is particularly suitable for a steel modular integrated building, can provide real-time, remote and autonomous monitoring for the structural corrosion situation conditions in the large-scale application of steel modular integrated buildings, and provide active protective measures, thus improving the reliability and safety of the structure, finding and removing potential safety hazards in time, and reducing the maintenance cost. A steel modular integrated building is used as an example for description below. It may be understood that the present disclosure is not limited thereto, and may also applied to the intelligent corrosion protection and monitoring of other steel structures.

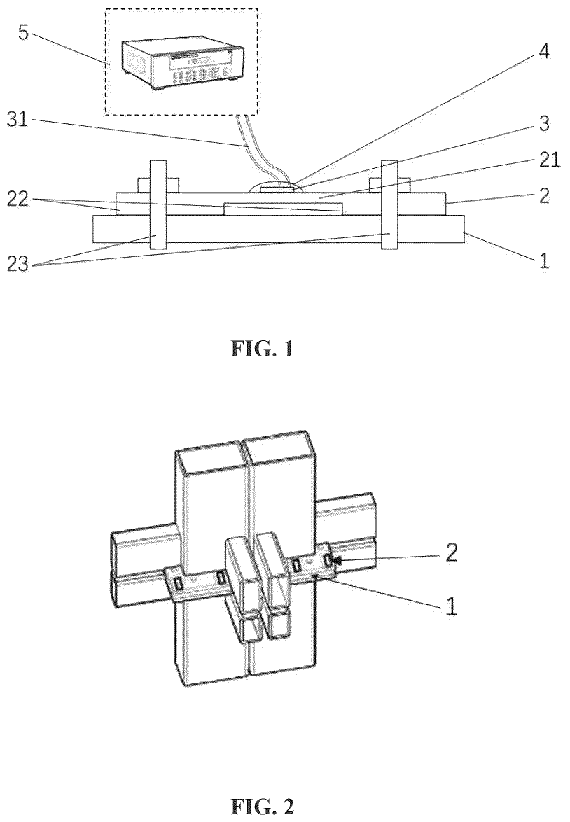

Please referring to FIG. 1 to FIG. 3, an intelligent corrosion protection and monitoring sensor system provided by an embodiment of the present disclosure includes an anode plate 2, and a thickness of a middle portion 21 of the anode plate 2 is less than that of two side portions 22 to form a bridge-shaped structure. The anode plate 2 is arranged on a steel structure 1 of a steel modular integrated module, the middle portion 21 of the anode plate 2 is not in contact with the steel structure 1 as there is a gap between the middle portion 21 of the anode plate 2 and the steel structure 1. The two side portions 22 of the anode plate 2 are in contact with the steel structure 1 and can conduct electricity. The steel structure 1 is, for example, a steel plate, more specifically, a connecting steel plate of the steel modular integrated building. One side face, away from the steel structure 1, of the middle portion 21 of the anode plate 2 is provided with a piezoelectric sheet 3, and the piezoelectric sheet 3 is electrically connected to a monitoring control system 5. Electric connection is any connection mode capable of achieving electric signal transmission, for example, the connection through a wire 31, or the connection through a wireless communication mode. Therefore, the monitoring control system 5 can control the application of a voltage to the piezoelectric sheet 3 to make the piezoelectric sheet 3 generate mechanical vibration and transmit the mechanical vibration to the anode plate 2 and the steel structure 1. The monitoring control system 5 may also be used to measure and analyze a voltage change of the piezoelectric sheet 3 caused by the mechanical vibration, thus monitoring a corrosion condition of the anode plate 2.

The intelligent corrosion protection and monitoring sensor system can monitor the corrosion status of the steel structure in real time through the cooperative work of these assemblies. The positive and inverse piezoelectric effects of a piezoelectric material (i.e., lead zirconate titanate, PZT) are used to monitor an impedance change of the steel structure, infer the degree of corrosion of the steel plate and monitor a health status of the structure. Meanwhile, the anode plate of a sacrificial anode (e.g., zinc, Zn) is used for cathodic protection, thus protecting the steel structure from corrosion to a certain extent and prolonging the corrosion life of the steel structure. The working principle and effects of the technical solution are described as follows.

The sacrificial anode attached to the steel structure for anticorrosion protection and a piezoelectric sheet physically connected to the sacrificial anode are added in the MIC building. The piezoelectric sheet can be used as an actuator (inverse piezoelectric effect) to generate mechanical vibration in the steel structure when the voltage is applied. Moreover, the piezoelectric sheet may also be used as a sensor (positive piezoelectric effect) to generate a voltage when subjected to mechanical stress. The monitoring control system applies an AC voltage with a certain frequency to the piezoelectric sheet to make the piezoelectric sheet generate vibration and transmit the vibration to the anode plate and steel structure, then the piezoelectric sheet receives the returned vibration (echo) to generate voltage, and the voltage is monitored and recorded by the monitoring control system and can reflect the impedance and admittance of the anode plate. The resonance frequency can be detected by applying voltages with different frequencies. When the resonance frequency of the anode plate and steel structure changes due to corrosion, these changes can be detected and analyzed by the piezoelectric sheet, thus providing information on the rate and degree of corrosion. Therefore, the impedance spectrum of the steel structure can be monitored by associating the change of impedance or admittance with the offset of the resonance frequency, the change of electrical impedance marked by the offset of resonance frequency in steel structure can be analyzed, and the degree of corrosion can be predicted according to the change of admittance or conductance.

The anode plate 2 man by made of, for example, zinc, magnesium, aluminum, or other alloys. Preferably, for example, the anode plate 2 is a zinc plate (pure Zn or Zn alloy). The anode plate 2 is used as a sacrificial anode material to form an electrochemical corrosion protection system. As the zinc (or other anode materials) has higher chemical activity than the steel, when the electrochemical corrosion occurs, the anode plate 2 corrodes prior to the steel structure 1 to release electrons, and these electrons flow to the steel structure 1 to form a protective current to inhibit the corrosion process of the steel structure 1, thus protecting the steel structure 1. Meanwhile, with the corrosion and consumption of the anode plate 2, there are changes on the surface characteristics of the anode plate 2, and these changes can be detected by the closely connected piezoelectric sheet 3. The change of current distribution and surface conditions makes the piezoelectric sheet 3 sense the change of impedance characteristics, and then the degree of corrosion of the anode plate 2 can be evaluated. The degree of corrosion of the anode plate 2 can reflect the corrosion condition and safety risk of the steel structure 1. Therefore, when the anode plate 2 is worn by corrosion, data analysis software in the monitoring control system can translate these monitored changes into indicators of the degree of corrosion.

After research, the anode plate 2 with a rectangular bridge-shaped structure is preferred in the present disclosure. Compared with an ordinary circular plate or square plate, the anode plate 2 in the preferred solution is thinner in the center and thicker in the side surface, and the piezoelectric sheet 3 attached to the middle portion 21 can enhance signal detection of the piezoelectric sheet 3 and improve the sensitivity of corrosion signal transmission, that is, the monitoring sensitivity is improved and the corrosion detection efficiency is optimized. The specific beneficial effects and principle include the following aspects:

(1) Enhancing sensing energy (the thinner middle portion increases the sensitivity): compared with the thicker two side portions, ae core portion of the bridge-shaped design is thinner to form a sensitive point, such that the piezoelectric sheet can be focused on a specific area where the change caused by corrosion is most obvious, without the damping effect from stiffener attachments of the steel. Due to the reduction of stiffness and the increase of flexibility, the thinner portion is more susceptible to the mechanical change. With the progress of corrosion, the structural integrity of the thinner portion is affected faster and more than that of the thicker portion, and the slight corrosion effect is more likely to change the physical properties (such as mass and stiffness) there. The local sensitivity is improved, and the change caused by corrosion can be detected earlier and more accurately. The acoustic characteristic change caused by corrosion is amplified, making the change of admittance with the vibration frequency more obvious, and the offset of the resonance frequency more prominent. As shown in FIG. 4a and FIG. 4b, FIG. 4a is graph of a test result when adopting an ordinary plate-like anode plate, and FIG. 4b is a graph of a test result when adopting a bridge-shaped plate-like anode plate.

(2) Enhancing mechanical response (in particular, bending response): a thickness difference between the middle and the side surface of the anode plate may cause a bending deviation, which makes the middle portion like a diaphragm. The middle portion can be bent more under the mechanical stress (caused by corrosion or external force). The bending enhances the mechanical response of the additional piezoelectric sheet, and thus the mechanical deformation can be converted into an electric signal. In addition, the structural shape formed by the thickness difference (between the thicker side and the thinner center) enhances the transmission of stress waves generated by the piezoelectric sheet during actuation, which is conducive to focusing energy on the center where the piezoelectric sheet is located, thus improving the detection of subtle changes in material properties.

(3) Improving signal transmission (dynamic response): the bridge-shaped structure is conducive to dynamic response to the corrosion, where the change of the middle portion (thinned due to corrosion) significantly changes the mechanical dynamics of the whole plate. The piezoelectric sheet is connected to the dynamic portion, and can receive an amplified mechanical signal (vibration, stress change) directly related to the corrosion process.

(4) Reducing noise in the signal detection (achieving the isolation of a sensing area): different structural areas (thick side and thin middle) are conducive to isolating the sensing area (where the piezoelectric sheet is located) from the mechanical noise that is not related to other parts of the anode plate, and such an isolation is conducive to reducing background noise in the voltage reading of the piezoelectric sheet. In addition, as the middle portion where the piezoelectric sheet is located is not in direct contact with the steel structure, the piezoelectric sheet can mainly record the vibration caused by corrosion, instead of the mechanical vibration of the steel structure. Therefore, a specific corrosion signal can be detected more clearly, thus reducing a signal-to-noise ratio. Moreover, a tailored frequency response can be achieved: bridge-shaped designs with different thicknesses can be tuned to a specific resonance frequency that is most affected by the corrosion process. Due to such an adjustment, the system can be highly responsive to specific types of corrosion expected in a sensor deployment environment.

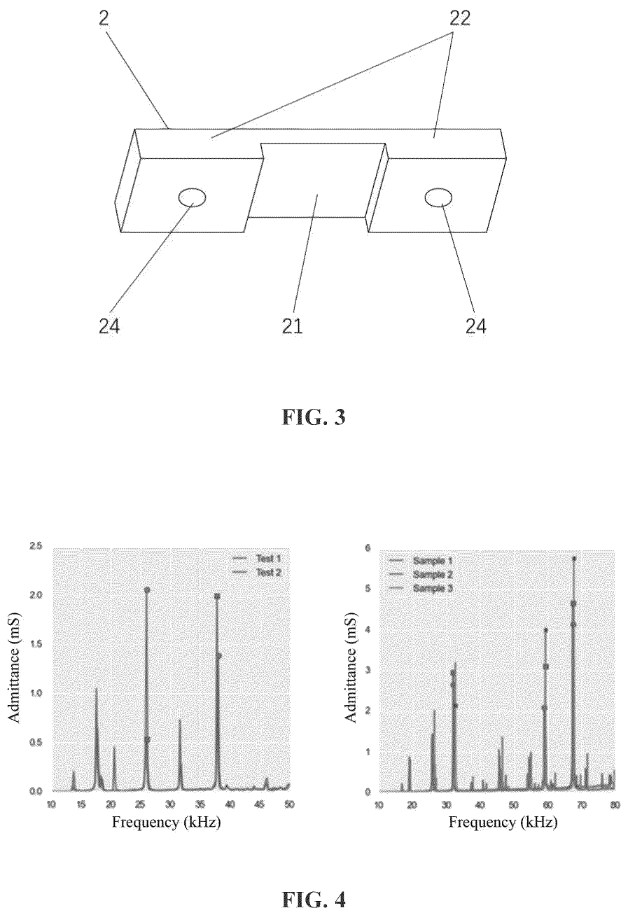

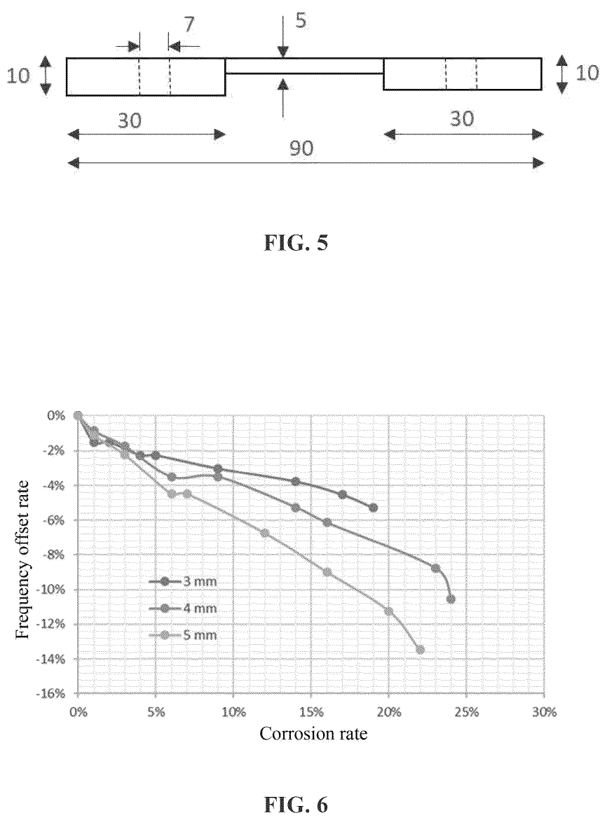

More specifically, please referring to FIG. 3 and FIG. 5 (The unit of dimensional data in FIG. 5 is mm). Preferably, the anode plate 2 is a rectangular zinc plate having a dimension of 90×30×10 (mm), the two side portions 22 of the anode plate 2 have a thickness of 10 mm, and the middle portion 21 of the anode plate 2 has a thickness of 5 mm. For the thickness design of the two side portions 22 of the anode plate 2, the thicker side portion can provide the necessary structural stiffness for the whole plate, and the consideration of the thinner middle portion is particularly important, which is conducive to maintaining the shape and integrity of the plate under various conditions (including mechanical stress). In addition, the thickness of the side portion can affect how the vibration or other signals caused by corrosion are transmitted to the piezoelectric sheet 3 to a certain extent. A thicker thickness can suppress the background noise signal better than a thinner thickness, thus improving the detection ability. For the thickness design of the middle portion 21, firstly, the middle portion should not be too thick, because a thicker material tends to be harder, which may reduce the sensitivity of zinc plate to detect frequency offset caused by corrosion process, and a large thickness requires more material, leading to high cost and weight. Meanwhile, the middle portion 21 should not be too thin, because it is necessary to ensure that sufficient structural support can be provided. It is found through research that the technical solution that the middle portion 21 has a thickness of 5 mm can provide sufficient structural support without significantly affecting the sensitivity of corrosion detection. Moreover, as shown in FIG. 6, when corrosion occurs, the most significant frequency shift is shown compared with the thickness design solution of 3 mm and 4 mm, indicating that 5 mm is the best thickness to maximize sensitivity.

(5) Optimizing acoustic impedance: the specific dimension and shape of the anode plate are tailored according to the present disclosure, thus optimizing acoustic impedance matching between the piezoelectric sheet and the anode plate. Such an optimization improves the energy transmission efficiency from the piezoelectric sheet to the anode plate during actuation, as well as during sensing, and improves the quality and reliability of the detection signal. Compared with a plate with the uniform thickness, the thinner middle portion of the bridge-shaped structure shows a lower damping effect, which leads to a clearer resonance peak in the frequency response, and thus the resonance frequency change caused by corrosion can be detected easier.

(6) Preventing electrochemical corrosion: due to the adoption of the bridge-shaped structure, the anode plate at the middle portion where the piezoelectric sheet is located is not in direct contact with the steel structure, thus preventing this portion from directly forming a galvanic cell with the steel structure and being corroded. If the conventional plate is used, the corrosion caused by direct contact not only damages the anode plate, but also leads to the corrosion data error of the sensor system, which may also lead to the deterioration of an operating environment of the sensor system, and the shortening of the service life of the sensor system, resulting in frequent replacement and maintenance, and the increase of the cost.

(7) Avoiding the influence of thermal expansion: different metals have different thermal expansion coefficients and can expand and contract at different rates when exposed to temperature changes. Therefore, if the zinc plate (anode plate) is in direct contact with the steel plate (steel structure) on the whole plane, stress may be produced at contact points due to different expansion rates, leading to the warping or cracking of the zinc plate. Meanwhile, additional noise may be introduced by the stress into voltage reading of the piezoelectric sheet, making the interpretation of a corrosion signal complicated and leading to wrong reading or misjudgment of the corrosion level. The non-contact solution of the bridge-shaped structure can reduce such risks, and enables the sensor system to operate under more stable conditions.

(8) Adaptability of multi-functional design: the dimension and shape of the bridge-shaped structure can adapt to various application requirements or structural limitations, which provides flexibility in deployment compared with the traditional one-size-fits-all design method.

In conclusion, the bridge-shaped structure of the anode plate not only improves the sensitivity of the monitoring system on early corrosion signs, but also improves the detection accuracy by improving the quality of mechanical-to-electrical signal conversion and concentrating the detection ability in the most critical area of the anode plate. Therefore, according to such a preferred design, the system can provide timely and accurate structure health evaluation more effectively, especially in an environment with large corrosion risks. Meanwhile, it is a deliberate design choice to improve the performance and reliability of a corrosion monitoring system by preventing a middle portion of the anode plate from making direct contact with the steel structure, which is conducive to maintaining the accuracy of detecting a corrosion signal by the sensor system and ensuring the service life and effectiveness.

The piezoelectric sheet 3 is also called a piezoelectric sensor, preferably, for example, the piezoelectric sheet 3 is a lead zirconate titanate piezoelectric sheet (also called PZT piezoelectric sheet, or PZT sensor), a main structure of which is a circular lead zirconate titanate patch, with a size of, for example, 10 mm in diameter and 1 mm in thickness. The piezoelectric sheet is mainly used for sensors and actuators (or excitors) in the electrochemical impedance technology. The piezoelectric sheet 3 is used as a core sensing element in the system of the technical solution. Due to the piezoelectric characteristics, the piezoelectric sheet 3 can generate mechanical vibration (excitor function) when a voltage is applied, or generate a voltage when subjected to mechanical stress (sensor function). The direct and indirect piezoelectric effects enable the piezoelectric sheet 3 to be used to monitor the corrosion status of the connected anode plate 2. By applying AC voltages with different frequencies through an electrochemical impedance spectrometer, the piezoelectric sheet 3 vibrates and transmits the vibrations to the steel structure 1 and the anode plate 2. The corrosion degree can be monitored by analyzing the impedance changes caused by these vibrations.

In the technical solution, it has obvious advantages to integrate excitation and sensing functions into a single piezoelectric chip in the system, especially in structural health monitoring. The specific beneficial effects and principle include the following aspects:

(1) Active testing and monitoring: an actuation function of the piezoelectric sheet enables the system to actively test the structural integrity of the building structure. Vibrations or stress waves are generated by actuation, and these waves are sent by the piezoelectric sheet into the structure. The behavior of these waves (how the waves are propagated, reflected, or damped) can provide key data about related material properties and conditions, such as stiffness, density and the existence of defects or corrosion.

(2) Dynamic response analysis: the system can evaluate a dynamic response of the structure by driving the piezoelectric plate to generate vibrations and then immediately switching to a sensing mode to monitor how these vibrations interact with the structure. This method is particularly effective in identifying weak links or deteriorated areas that may not be obvious under static conditions.

(3) Enhancing sensitivity to change: the change of a response mode can be continuously monitored and detected immediately by frequently or continuously stimulating the structure by the piezoelectric sheet, thus discovering new or deteriorating defects, such as the development of corrosion.

(4) Structure simplicity and cost benefits: as there are both actuation and sensing functions in the same device (piezoelectric sheet), the system architecture can be simplified, hardware requirements can be reduced, and the overall cost and complexity of mounting and maintenance can be lowered.

(5) Improving data accuracy and reliability: a difference caused by differences (such as differences in position or sensitivity) between different devices can be minimized by generating and detecting the vibration using the same device (piezoelectric sheet) can be minimized. Therefore, more accurate and reliable data can be obtained.

(6) Real-time feedback and control: the same device (piezoelectric sheet) can be immediately switched to sensing from actuation, thus achieving real-time monitoring and analysis. This rapid feedback loop is crucial to detect the critical situation that needs immediate attention in time, thus improving the safety and prolonging the service life of the structure.

(7) Space utilization and weight efficiency: in an environment where the space or weight of the device needs to be concerned (for example, in aerospace or automobile applications), combining the actuation and sensing functions into one unit (piezoelectric sheet) can reduce the physical footprint and load of the monitoring system.

(8) Cooperative operation: when the actuation and sensing are executed by the same device (piezoelectric sheet), the perfect coordination between the generation and reception of signal is ensured, which is crucial for echo or impedance-based measurement and other technologies.

In conclusion, the dual functions of the piezoelectric sheet in actuation and sensing enhance the effectiveness of structural health monitoring. This integration not only simplifies the design and operation of the system, but also improves the accuracy, efficiency, and responsiveness of monitoring, which is crucial for maintaining the safety and integrity of the building structure.

Please referring to FIG. 1, preferably, an encapsulation layer 4 is covered on the piezoelectric sheet 4 and the anode plate 2 around the piezoelectric sheet 4. The encapsulation layer 7, for example, employs epoxy resin, thus protecting the piezoelectric sheet 3 and ensuring that the piezoelectric sheet 3 is tightly and firmly attached to the anode plate 2, and prolonging the service life.

Preferably, the anode plate 2 and the steel structure 1 are mounted and connected by a bolt connector 23. Specifically, for example, the two side portions 22 of the anode plate 2 and the steel structure 1 are provided with bolt holes 24. The bolt connector 23 includes a ceramic bolt and a ceramic nut which are matched with each other, and the ceramic bolt passes through the bolt hole 24. The ceramic nut is threaded to a tail end of the ceramic bolt in a matched manner. In a specific embodiment, the bolt hole 24 has a diameter of 7 mm, and the bolt connector 23 employs a M6 ceramic bolt pair. The anode plate 2 is connected and fixed to the steel structure of the steel modular integrated building by bolts, which makes the anode plate 2 serving as a sacrificial anode easy to replace. Moreover, the ceramic material has better chemical corrosion resistance than metals, and thus the introduction of an additional corrosion source into a metal corrosion monitoring system can be avoided.

Generally, the piezoelectric sheet 3 is connected to a monitoring control system 5 by a wire 31, and the wire 31 is used to achieve connection and signal transmission. The wire 31 usually adopts the standard color in electrical connection, for example, red and black wires, with a red line representing a positive electrode and a black line representing a negative electrode. In this system, the wire 31 is welded to two electrodes of the piezoelectric sheet 3, and then is connected to the electrochemical impedance instrument. Therefore, the black and red wires are important media to achieve the communication between the sensor function and the electrochemical impedance instrument, which ensures the effective operation of the monitoring system. These wires must have sufficient electrical conductivity, mechanical strength, and corrosion resistance, thus ensuring long-term stable operation in humid and possibly corrosive environments.

The control and switching of the actuation and sensing functions of the piezoelectric sheet 3 can be controlled by the monitoring control system 5. The monitoring control system is, for example, an electronic system, which can rapidly change an operation mode of the piezoelectric sheet. Specifically, the monitoring control system can control when and how to apply voltage to the piezoelectric sheet and when to switch to the sensing mode (or reading mode) to measure the voltage generated by the piezoelectric sheet. The monitoring control system 5 includes, for example, an electrochemical impedance spectrometer. In addition, the monitoring control system manages the switching of functional modes by precise timing and sequencing. For example, the monitoring control system may apply a short-pulse voltage to drive the piezoelectric sheet, and then quickly switch to the sensing mode to measure the response. The time can be adjusted according to specific detection demands.

A method for manufacturing an intelligent corrosion protection and monitoring sensor system is further provided. The method is used for manufacturing the intelligent corrosion protection and monitoring sensor system. In a preferred embodiment, the method includes the following steps:

Step S11. Connection of piezoelectric sheet, a wire 31 is welded to the lead wire 31. More specifically, thin red and black wires with the same length are welded to the lead zirconate titanate piezoelectric sheet by soldering, and then are connected to the electrochemical impedance instrument for testing later. In the technical solution, the red and black wires with equal length are directly welded to the piezoelectric sheet to ensure consistent and reliable wire connection, enhance the connection reliability, and reduce the risk of connection failure under harsh environmental conditions.

Step S12. Fixation of anode plate and piezoelectric sheet: an anode plate 2 (such as zinc plate) is heated to, for example, 250° C. on a heating stage, and the piezoelectric plate 3 is fixed to the middle portion 21 of the anode plate 2 by a lead-free solder (such as solder sheet) and solder paste (preferably BGA solder paste, the main component of which is phosphoric acid). The piezoelectric sheet 3 is pressed by an iron nugget (for example, a 50-gram cylindrical iron nugget) to ensure that the lead-free solder completely melts and is firmly attached between the anode plate 2 and the piezoelectric sheet 3. After the welded portion is cooled to a room temperature, it is ensured that the piezoelectric sheet 3 and the anode plate 2 have been fixed. The connection method of the technical solution not only ensures firm mechanical bonding, and but also can provide better thermal stability compared with the general normal binder. The use of the lead-free solder conforms to environmental safety and health standards, and has advantages compared with potentially dangerous materials. In addition, weighted iron nuggets for uniform bonding is a novel method, which can ensure the uniform distribution of pressure and heat, and achieve more uniform and lasting bonding between the piezoelectric sheet and the anode plate, thus reducing the risk of falling off or bonding failure under corrosive conditions. In the existing related technical solutions, the measures to further ensure the connection effect during production are usually easily overlooked.

Step S13. Sample encapsulation: epoxy resin is used to encapsulate the fixed piezoelectric sheet 3 and anode plate 2. After cooling, the epoxy resin hardens to form an encapsulation layer 4 to protect the connection portion and provide better durability. In the technical solution, epoxy resin protective encapsulation is preferred, which not only can protect the piezoelectric sheet from environmental factors, but also can enhance the overall structural integrity of the sensor system, thus providing better mechanical impact resistance and chemical corrosion protection.

Step S14. Mounting to steel structure: the anode plate 2 with the piezoelectric sheet 3 is mounted and fixed to the steel structure 1 (steel plate) of the MiC building by a bolt (employing a ceramic bolt or screw). For the MiC building, the anode plate is fixedly integrated into a modular structure through bolt connection, the practical application in the actual structure is emphasized, the adaptability and expansibility of the sensor system are enhanced, and the system is more suitable for different building environments.

An application method of an intelligent corrosion protection and monitoring sensor system is further provided. The intelligent corrosion protection and monitoring sensor system is adopted. In a preferred embodiment, the method includes the following steps:

Step S2. Corrosion experiment: in a state that the steel structure is not fixedly mounted in the steel modular integrated building (for example, after the above step S14, the steel structure is subjected to corrosion experiment prior to mounting, or some sensor system samples are separately prepared for corrosion experiment, etc.), the steel structure and the anode plate are soaked in a 3.5 wt % NaCl solution for a certain period to simulate a corrosion environment. Electrochemical impedance test and data acquisition and analysis are carried out through the monitoring control system. For example, through the electrochemical impedance test, data about the corrosion condition of the zinc plate are collected and analyzed to determine the corrosion rate of the zinc plate over time. The principle of the intelligent corrosion protection and monitoring sensor system is based on electrochemical impedance spectroscopy. As a sensor and actuator, the piezoelectric sheet can monitor the corrosion condition of the anode plate and a steel structure surface in contact with the anode plate. The impedance data obtained by analysis can help to understand the corrosion process of materials and provide basis for maintenance and prevention.

Specifically, in Step S2, performing the electrochemical impedance test and data acquisition and analysis further includes the following steps:

Step S21. An initial weight of the anode plate and a current weight (an initial state before corrosion is tested and recorded) of the anode plate after corrosion are recorded at different corrosion time (or soaking time). An AC voltage with different frequencies (10 kHz-30 kHz) is applied to the piezoelectric sheet through the monitoring control system at different corrosion time (including the initial state before corrosion) to make the piezoelectric sheet vibrate, then frequency resonance of the piezoelectric sheet caused by the corrosion of the anode plate is monitored and recorded, and admittance of the piezoelectric sheet is collected and recorded to form a data record form and/or a data relationship graph. Resonance frequencies of the anode plate in multiple different corrosion states are obtained according to a relationship between the admittance and the frequency in the data record form and/or the data relationship graph. For example, as shown in Table 1 below (Table 1 includes both the data measured in this step and the data calculated in the following steps).

TABLE 1
Experimental data form of corrosion experiment and data collection and analysis

| For | | | | | | | | | | | |
|---|---|---|---|---|---|---|---|---|---|---|---|
| anode | | | | | | | | | | | |
| plate | | | | | | | | | | | |
| (zinc) | 6 h | 12 h | 24 h | 96 h | 144 h | 168 h | 14 h | 21 h | 30 h | 35 h | 45 h |
| Initial | 154.39 | 154.39 | 154.39 | 154.39 | 154.39 | 154.39 | 154.39 | 154.39 | 154.39 | 154.39 | 154.39 |
| weight, | | | | | | | | | | | |
| W₀ | | | | | | | | | | | |
| Current | 153.4 | 152.23 | 150.03 | 138.91 | 135.72 | 128.85 | 101.22 | 82.59 | 67.23 | 59.09 | 30.6 |
| weight, | | | | | | | | | | | |
| W | | | | | | | | | | | |
| Weight | 0.99 | 2.16 | 4.36 | 15.48 | 18.67 | 25.54 | 53.17 | 71.8 | 87.16 | 95.3 | 123.79 |
| loss | | | | | | | | | | | |
| Weight | 0.64 | 1.39 | 2.82 | 10.02 | 12.09 | 16.54 | 34.43 | 46.5 | 56.45 | 61.72 | 80.18 |
| loss rate | | | | | | | | | | | |
| (%) | | | | | | | | | | | |
| Resonance | 26.86 | 27.27 | 27.69 | 28.31 | 28.54 | 28.99 | 29.01 | 29.32 | 29.5 | 29.67 | 30.75 |
| frequency | | | | | | | | | | | |
| (KHz, | | | | | | | | | | | |
| initial | | | | | | | | | | | |
| being | | | | | | | | | | | |
| 26.34) | | | | | | | | | | | |
| Frequency | 1.97% | 3.53% | 5.13% | 7.48% | 8.35% | 10.06% | 10.14% | 11.31% | 12.00% | 12.64% | 16.74% |
| offset | | | | | | | | | | | |
| rate | | | | | | | | | | | |

Step S22. A frequency offset rate and a corrosion rate of the anode plate are calculated according to the data obtained in Step S21.

$$Frequency offset rate = ( current resonance frequency - initial resonance frequency ) / initial frequency ; and$$

$$corrosion rate = ( initial weight - current weight ) / initial weight / corrosion time . The time may employ corresponding time periods , such as 6 h , 12 h , etc .$$

Step S23. According to the data obtained in Step S22, a linear function relationship between the frequency offset rate and the corrosion rate is obtained by linear regression analysis.

Step S24. For the intelligent corrosion protection and monitoring sensor system applied to the steel structure mounted in practical engineering, electrochemical impedance test and data acquisition and analysis are performed through a monitoring control system, and a frequency offset rate and/or a corrosion rate is predicted based on the linear functional relationship between the frequency offset rate and the corrosion rate obtained in step S23, thus monitoring a corrosion condition.

The concept and principle of the process from Step S22 to Step S24 are as follows.

### (I) Change Relationship Between Corrosion Rate and Frequency of Zinc Plate

As can be seen from the experimental data obtained in Step S21 that the corrosion of the zinc plate (anode plate) in 3.5 wt % NaCl solution over time leads to weight loss, accompanied with the change of G value (admittance) in electrochemical impedance. These data show the weight loss of the zinc plate and the change of resonance frequency at different time points, and the relationship between the corrosion rate and the frequency can be understood by analyzing these data.

Firstly, a weight loss ratio of the zinc plate and a change ratio of the resonance frequency can be calculated. The weight loss ratio refers to a ratio of the weight loss to the initial weight of the zinc plate in specific period, usually expressed as a percentage. The frequency change ratio refers to a ratio of the change of resonance frequency to the initial frequency in the specific period, usually expressed as a percentage.

The following results can be obtained from the data:

(1) With the increase of time, the weight of the zinc plate continues to decrease, and the weight loss ratio gradually increases, indicating that the corrosion effect in the NaCl solution is continuous.

(2) With the increase of corrosion time of the zinc plate, the resonance frequency also changes, indicating that the change of the resonance frequency is related to the corrosion degree of the zinc plate. With the development of the corrosion of the zinc plate, the overall resonance frequency tends to increase, which may be because the resonance frequency of zinc plate increases with the decrease of its mass (the resonance frequency of a light object is usually higher).

(3) There is a positive correlation between the weight loss ratio and the frequency change ratio, that is, with the increase of the weight loss ratio, the change ratio of the resonance frequency also increases.

A relationship between a G value and the frequency is established, and it is found that the corrosion rate increases and G value moves to the right. Therefore, the relationship between the corrosion rate and the change of G value can be obtained according to the change of the G value. According to the experimental results, it can be concluded that there is a certain relationship between the corrosion rate and the change of corrosion parameters (i.e., G value) monitored by the piezoelectric sheet. The rightward movement of the G value indicates the change of the electrochemical impedance during corrosion, which is the most significant parameter change caused by corrosion.

On this basis, the change of G value can be used as a sensitive indicator for corrosion monitoring. By monitoring the change of the G value in real time, the corrosion process can be effectively tracked and predicted, and then necessary protective measures can be taken to prolong the service life of the material.

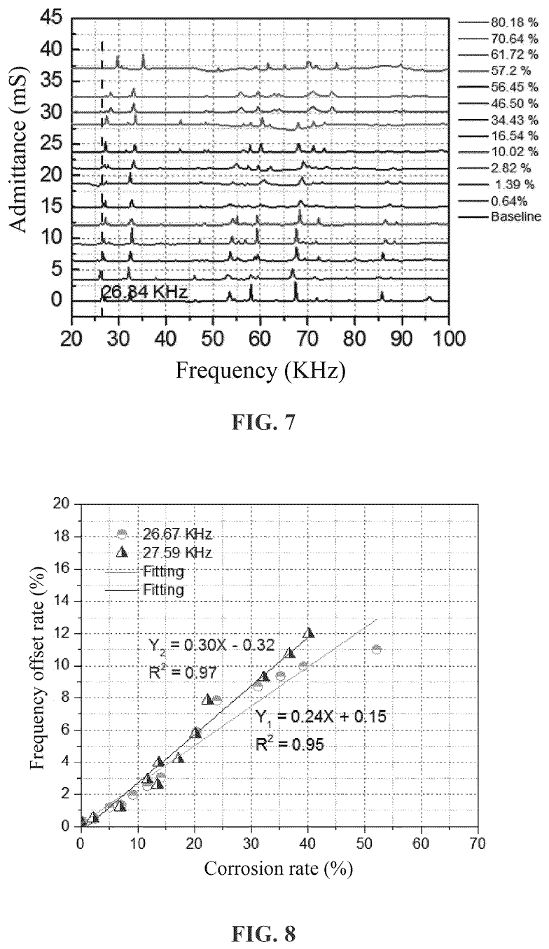

In order to achieve this target, a monitoring model can be established, the model can continue to record the change of the G value, and associate the change of the G value with the corrosion rate. As shown in FIG. 7 obtained based on experimental data, the order of curves distributed in the figure from bottom to top is the same as the progress order of the corrosion process. With the change of the frequency, a peak point of the G value (admittance) corresponds to the resonance frequency. It can be obtained that the resonance frequency shifts (increases) to the right with the progress of corrosion.

### (II) Change Relationship Between Corrosion Rate of Zinc Plate and Frequency Offset Rate

In order to establish the relationship between the frequency offset rate and the corrosion rate according to the data provided above, these two parameters need to be defined at first: the frequency offset rate refers to a change rate of the resonance frequency in a specific period. A calculation method for the frequency offset rate is that frequency offset rate=(current frequency−initial frequency)/initial frequency. The corrosion rate can be expressed by the weight loss rate, and a calculation method for the corrosion rate is that corrosion rate=(initial weight−current weight)/initial weight/time.

The known data points provide the weight loss and frequency change at different time points. These data points can be used to establish a linear function, and thus there is a linear relationship between the frequency offset rate (y axis) and the corrosion rate (x axis). The usual form of the linear function is: y=mx+b, where y is the frequency deviation rate, x is the corrosion rate, m is a slope, and b is intercept. The linear regression analysis can be used to find the most suitable linear function for data points. Linear regression is used to calculate a straight line that minimizes the sum of squares of the distances between all data points and a regression line. As shown in FIG. 8, the linear function relationship between the frequency offset rate and the corrosion rate is y1=0.24x+0.15, y2=0.30x−0.32. It can be understood that the linear function relationship may be different for different specific situations (for example, including different anode plate dimensions, different corrosion environments, different linear regression/fitting modes, etc.).

Once determined, the linear relationship (equation) can be used to predict the frequency offset rate at a given corrosion rate, or conversely, the frequency offset rate can be used to estimate the corrosion rate. This relationship is useful for real-time monitoring of the degree of corrosion. Once the frequency offset rate is known, the corrosion rate can be quickly estimated. The linear model (equation) may be embedded into the corrosion monitoring system as a prediction tool to achieve real-time corrosion monitoring.

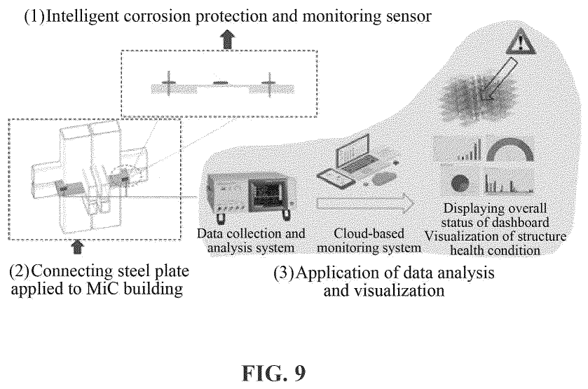

Further, please referring to FIG. 2 and FIG. 9, the intelligent corrosion protection and monitoring sensor systems are distributed at different node positions of the steel modular integrated building. The application method further includes Step S3, continuously monitoring by the monitoring control system at set time intervals, and generating a visualization chart to reflect a corrosion condition at each position of the steel modular integrated building, and/or giving an alarm to remind staff to check and intervene in time. As shown in FIG. 9, all piezoelectric sheets are connected to the monitoring control system. The monitoring control system includes a data collection and analysis system (e.g., an electrochemical impedance spectrometer), and a computer system. The data collection and analysis system can transmit data remotely through cloud technology, and then form visual real-time monitoring through the computer software. For example, the position of each piezoelectric sheet (and anode plate) is displayed in a perspective view of the MiC building, and the corrosion condition is expressed in color, and then the corrosion condition is displayed in a statistical chart similar to a dashboard, thus facilitating the staff to intuitively grasp the structural health condition of the MiC building as a whole. Once corrosion signs are detected, the system can give an alarm and allow maintenance personnel to inspect and intervene in time to prevent further corrosion damage. A system capable of monitoring corrosion in real time and providing active protective measures is provided, which improves the reliability and safety of the structure, and reduces the maintenance cost.

In conclusion, the main concept of the intelligent corrosion protection and monitoring sensor system and method provided by the present disclosure is to attach a piezoelectric sheet (PZT patch) to an anode plate (zinc plate), thus performing intelligent corrosion protection and health monitoring on a steel structure. Compared with the prior art, the technical solution provided by the present disclosure has the following beneficial technical effects:

(1) In the present disclosure, after the piezoelectric sheet 3 is connected to a main body structure (anode plate 2 and steel structure 1), the piezoelectric sheet 3 is vibrated by an impedance analyzer, and alternating voltages with different frequencies are applied to couple with the main body structure. Therefore, the measured electrochemical impedance signal displays a mechanical impedance of the main body structure. The changes in the electric impedance indicate structural damage caused by corrosion or cracks. The electrochemical impedance (EMI) technology is considered as one of the most promising methods to develop structural health monitoring (SHM) systems on various structures. As the electrochemical impedance method is for a high-frequency signal, it is sensitive to local damage. The piezoelectric sheet (PZT patch) itself has the characteristics of low cost, small volume, non-invasive, and linear. These characteristics make the electrochemical impedance technology efficient and accurate, and it is possible to provide real-time, remote and autonomous monitoring for large-scale applications at low cost. In the system, the piezoelectric sheet 3 is mounted on the anode plate 2. Therefore, the piezoelectric sheet 3 not only can detect the structural changes caused by corrosion, but also can monitor the changes in the sacrificial process of the anode plate 2. The system is connected to the monitoring control system 5 for data collection and analysis by the wire 31. The monitoring control system 5 can be used to monitor an impedance spectrum of PZT in real time, and to analyze these data to identify the corrosion signs.

(2) The anode plate is mounted on the steel plate, and the sensor system can actively slow down the corrosion speed of the steel plate and improve the durability of the steel structure using a sacrificial anode protection principle. The sensitivity of the bridge-shaped design of the anode plate is improved, and thus the early corrosion can be detected. However, the uniform thick plate cannot be greatly affected by these corrosions, and the corrosion is hard to be detected. In this way, corrosion progress can be detected earlier and monitored more accurately. Early detection is crucial for preventive maintenance, overall safety and maintenance planning, and maintenance cost can be significantly reduced by solving problems before escalation. In addition, the focusing stress and strain of the bridge-shaped middle portion connected to the piezoelectric sheet lead to stronger signal response of the same input, thus improving the signal-to-noise ratio in the measurement, which is crucial in the environment where the background noise is high or the sensor must run for a long distance.

(3) According to the design of the PZT patch, the PZT patch not only can serve as a sensor to detect the structural change, but also can serve as an actuator to actively excite structural vibration. The dual function greatly enhances its application efficiency and flexibility in structural health monitoring. In the present disclosure, the positive and inverse piezoelectric effects of the piezoelectric patch are comprehensively applied. The positive piezoelectric effect is used to detect an electrical signal generated by the structural change, and the inverse piezoelectric effect is used to generate structural vibration. Such a comprehensive application can accurately control and measure the response of the structure.

(4) In the present disclosure, the nondestructive inspection of the structure integrity is achieved, and there is no need to perform physical cutting or sampling analysis on the structure itself.

(5) The piezoelectric sheet can be easily integrated into various structures due to its small size and light weight, and in cooperation with an automatic data collection and analysis system, the manual monitoring demand is reduced.

(6) The accuracy of data analysis is higher, the finer quality data and change and frequency data mean that the change of physical and chemical properties of the anode plate caused by corrosion can be drawn more accurately. Such an accuracy is crucial for developing a reliable corrosion process prediction model.

(7) A potential problem can be predicted by continuously monitoring a health status of the structure, the replacement is convenient after the zinc plate is corroded. This technical solution is conducive to improving preventive maintenance efficiency of the steel structure, thus avoiding unexpected failures, and reducing the risk of emergencies.

(8) This technical solution has a wide application potential, which is not only suitable for the steel structure building, but also can be extended to other systems made of steel structures. The corrosion status of the structure can be remotely monitored in real time, maintenance teams can know and make response to corrosion problems in time without going to the site for inspection. The technical solution provided by the present disclosure may also be applied to remote health monitoring of other complicated engineering structures, such as bridges and ships.

What is claimed is:

1. An intelligent corrosion protection and monitoring sensor system, comprising an anode plate, wherein a thickness of a middle portion of the anode plate is smaller than that of two side portions of the anode plate to form a bridge-shaped structure; the anode plate is mounted on a steel structure, a gap is formed between the middle portion of the anode plate and the steel structure, and the two side portions of the anode plate are in contact with the steel structure; a piezoelectric sheet is provided on a side surface, away from the steel structure, of the middle portion of the anode plate, and the piezoelectric sheet is electrically connected to a monitoring control system; the monitoring control system is capable of controlling application of a voltage to the piezoelectric sheet to make the piezoelectric sheet generate mechanical vibration and transmit the mechanical vibration to the anode plate and the steel structure, and the monitoring control system is also capable of measuring and analyzing a voltage change of the piezoelectric sheet caused by the mechanical vibration so as to monitor a corrosion condition.

2. The intelligent corrosion protection and monitoring sensor system according to claim 1, further comprising an encapsulation layer covered on the piezoelectric sheet and the anode plate around the piezoelectric sheet.

3. The intelligent corrosion protection and monitoring sensor system according to claim 1, wherein the anode plate and the steel structure are mounted and connected by a bolt connector.

4. The intelligent corrosion protection and monitoring sensor system according to claim 3, wherein the two side portions of the anode plate and the steel structure are provided with bolt holes, the bolt connector comprises a ceramic bolt and a ceramic nut which are matched with each other, and the ceramic bolt passes through the bolt hole.

5. The intelligent corrosion protection and monitoring sensor system according to any one of claims 1 to 4, wherein the anode plate a zinc plate, and/or the piezoelectric sheet is a lead zirconate titanate piezoelectric sheet.

6. The intelligent corrosion protection and monitoring sensor system according to any one of claims 1 to 4, wherein the monitoring control system comprises an electrochemical impedance spectrometer.

7. The intelligent corrosion protection and monitoring sensor system according to any one of claims 1 to 4, wherein the middle portion of the anode plate has a thickness of 5 mm, and the two side portions have a thickness of 10 mm.

8. A method for manufacturing the intelligent corrosion protection and monitoring sensor system of claim 2, comprising the following steps:
step S11, welding a wire to the piezoelectric sheet;
step S12, heating the anode plate on a heating stage, and fixing the piezoelectric sheet to a middle portion of the anode plate using a lead-free solder and solder paste, pressing against the piezoelectric sheet using an iron nugget to ensure that the lead-free solder melts completely and is attached firmly between the anode plate and the piezoelectric sheet; and completing the fixation of the piezoelectric sheet and the anode after cooling;
step S13, encapsulating the piezoelectric sheet and the anode plate using epoxy resin, cooling, and then hardening the epoxy resin to form the encapsulation layer; and
step S14, mounting and fixing the anode plate to the steel structure by bolted connection.

9. An application method of the intelligent corrosion protection and monitoring sensor system of claim 1, comprising the following steps:
step S2, soaking the steel structure and the anode plate in a solution to simulate a corrosive environment, and performing electrochemical impedance test and data acquisition and analysis through the monitoring control system;
performing the electrochemical impedance test and data acquisition and analysis further comprises the following steps:
step S21, respectively recording an initial weight of the anode plate and a current weight of the anode plate after corrosion at different corrosion time; applying an AC (alternating current) voltage with a frequency of 10 kHz-30 kHz to the piezoelectric sheet through the monitoring control system at different corrosion time, making the piezoelectric sheet vibrate, then monitoring and recording frequency resonance of the piezoelectric sheet caused by the corrosion of the anode plate, and collecting admittance to form a data record form and/or a data relationship graph; and obtaining resonance frequencies of the anode plate in a plurality of different corrosion states according to a relationship between the admittance and the frequency in the data record form and/or the data relationship graph;
step S22, calculating a frequency offset rate and a corrosion rate of the anode plate according to the data obtained in the step S21;
$$wherein frequency offset rate = ( current resonance frequency - initial resonance frequency ) / initial frequency ; and$$
$$corrosion rate = ( initial weight - current weight ) / initial weight / corrosion time ;$$
step S23, according to the data obtained in the step S22, obtaining a linear function relationship between the frequency offset rate and the corrosion rate by linear regression analysis; and
step S24, for the intelligent corrosion protection and monitoring sensor system applied to the steel structure mounted in practical engineering, performing electrochemical impedance test and data acquisition and analysis through a monitoring control system, and predicting a frequency offset rate and/or a corrosion rate based on the linear functional relationship between the frequency offset rate and the corrosion rate obtained in the step S23, thus monitoring the corrosion condition.

10. The application method of the intelligent corrosion protection and monitoring sensor system according to claim 9, wherein the intelligent corrosion protection and monitoring sensor systems are distributed at different node positions of a steel modular integrated building;
the method further comprises Step S3, continuously monitoring by the monitoring control system at set time intervals, and generating a visualization chart to reflect a corrosion condition at each position of the steel modular integrated building, and/or giving an alarm to remind staff to check and intervene in time.
